(19) United States
(12) Patent Application Publication
(10) Pub. No.: US 2007/0088114 A1
(43) Pub. Date: Apr. 19, 2007

(54) THERMOSET PARTICLES AND METHODS FOR PRODUCTION THEREOF

(75) Inventor: Soheil Asgari, Wiesbaden (DE)

Correspondence Address: DORSEY & WHITNEY LLP;INTELLECTUAL PROPERTY DEPARTMENT, 250 PARK AVENUE, NEW YORK, NY, 10177, US

(73) Assignee: Blue Membranes GmbH, Rheingaustrasse (DE)

(21) Appl. No.: 11/550,623

(22) Filed: Oct. 18, 2006

Related U.S. Application Data
(60) Provisional application No. 60/727,975, filed on Oct. 18, 2005.

(51) Int. Cl. C08K 3/22

(52) U.S. Cl. 524/431; 524/493; 524/450; 524/445; 524/494

(57) ABSTRACT

Thermoset-based particles and processes for the manufacture thereof can be provided, where the particles may have a spherical or fibrous shape. A reaction mixture can be provided that includes a thermosetting resin, a crosslinker, a surface active agent, and a solvent. The reaction mixture can be an emulsion, a suspension or a dispersion which may optionally be sprayed or electrospun. Crosslinking of the resin can be performed by addition of an initiator or by exposing the reaction mixture to heat and/or radiation to form polymerized particles. The particles may be dried, sintered, pyrolyzed or carbonized, and/or impregnated with an active agent.

### CROSS-REFERENCE TO RELATED APPLICATION(S)

The present application claims priority from U.S. Patent Application No. 60/727,975, filed Oct. 18, 2005, the entire disclosure of which is incorporated herein by reference.

### BACKGROUND OF THE INVENTION

Thermoset materials can be produced using conventional polymerization techniques, for example, using molding procedures with heated molds and high temperatures, and/or by applying pressure in the range of up to about 20 bar. Conventional thermoset polymers can be polycondensation materials such as, e.g., phenolic or amino resin molding materials. Thermosetting plastics or thermosets may be produced using polyaddition mechanisms and/or by polymerization of cross-linked materials or mixtures of materials such as, for example, epoxy resins, melamine resins, urea resins, unsaturated polyester resins, alkyd resins, etc. Polyurethane product compositions and reactive thermosetting resins may be used, e.g., to provide thermosetting plastics or as compression molding materials for producing articles, decorative laminates, casting resins or adhesives. Such materials can be used, e.g., for use in surface protection, and in chip board and flake board production.

There may be an increasing demand for small-scale (e.g. micron- or nano-scale) discrete materials for advanced applications in electronics, mechanics, optics, medical device technology, pharmaceutical applications, etc. Such materials can become increasingly important for coatings, energy technologies, sensor technologies, chemical processing and the like. Therefore, there may be an increasing demand to provide thermoset materials that include conventional advantages and characteristics of thermosets such as, for example, mechanical stability, dielectric properties and chemical resistance, where such materials may be applicable in particulate form.

Conventional particles formed from thermosetting precursors can be used as powders for powder coating applications. Mixtures of thermosetting precursors which may include, e.g., fillers and/or other compounds such as coupling agents, coloring agents and the like, can be blended using dry or melt blending methods, and may then be solidified by cooling, pulverized and classified or sorted. Particles of particular sizes or within certain size ranges can be collected and used in powder coating applications. Conventional pulverization techniques can be used such as, e.g., jet mill or vertical roller mill processes or the like, and they may include cryogenic treatments.

Pulverization of polyurethane containing materials using, for example, cryogenic processes or roll mills is described in, e.g., U.S. patent application Ser. No. 09/748,307. A technique for comminuting or pulverizing polyurethane-containing materials to produce fine particles is described, e.g., in International Patent Publication No. WO2004022237.

Thermoset materials can be used as precursor materials for carbonization. There may be an increasing demand for functionalized nano- and micro-morphous carbon particles for, e.g., various technology applications such as those indicated herein above. Carbon based particles may be used, e.g., as molecular sieves for chemical processing, as components in membranes, e.g. in mixed matrix membranes, and/or as drug-delivery particles. Carbon particles may be provided in a form such as, e.g. activated carbon, nano-tubes or nano-fibers. Certain techniques that may be used to synthesize carbon nanotubes include arc discharge techniques and laser ablation techniques, which may be performed in a laboratory scale, chemical vapor deposition techniques, or vapor phase growth techniques.

Such techniques may requires complex processes and appropriate control of process parameters to produce carbon particles. Further, efficiency of such processes may be low and manufacturing costs may be high.

Conventional techniques for processing thermosetting plastics and articles may not be suitable for forming micron or sub-micron-scale particles. Furthermore, pulverization techniques may not be suitable for providing thermally and/or chemically stable thermoset material, because the resulting powders can be appropriate for powder coating processing and may require thermal processing to melt such powders to form a film.

Conventional powder manufacturing processes also may not be suitable for providing thermoset-based particles to be used as precursors for further functionalization of carbon based particle species.

### SUMMARY OF EXEMPLARY EMBODIMENTS OF THE INVENTION

It is therefore an object of the present invention to provide a method for manufacturing thermosetting materials in the form of thermoset-based particles at a relatively low cost.

A further object of the present invention is to provide a method for the manufacture of thermoset-based particles that allows for modification of the resulting material properties such as, for example, a thermal coefficient for expansion, electrical, dielectric, conductive, semiconductive, magnetic and/or optical properties, by varying material composition and/or process parameters.

In exemplary embodiments of the present invention, a method for manufacturing a thermoset material can be provided which can include, e.g.: (i) providing at least one thermosetting resin, at least one crosslinker, at least one surface active agent, and at least one solvent; (ii) preparing a reaction mixture that includes the thermosetting resin, the crosslinker, the surface active agent, and the solvent; (iii) crosslinking the thermosetting resin to produce a thermoset material; and (iv) removing the solvent from the material.

According to further exemplary embodiments of the present invention, a method for manufacturing a thermoset fibrous material can be provided which can include, e.g.: (i) providing at least one thermosetting resin, at least one crosslinker, at least one surface active agent, and at least one solvent; (ii) preparing a reaction mixture that includes the thermosetting resin, the crosslinker, the surface active agent, and the solvent; (iii) partially crosslinking the thermosetting resin; and (iv) electro-spinning the reaction mixture to produce thermoset fibers.

In certain exemplary embodiments of the present invention, the crosslinker can be added to the thermosetting resin, and this mixture can then be added to the solvent. A crosslinker may also be added to a reaction mixture that includes a thermosetting resin. The reaction mixture can be prepared by adding the thermosetting resin to the solvent and surface active agent while it is in a liquid and/or molten state. The reaction mixture can also be prepared by adding the thermosetting resin and/or a mixture of the resin and the crosslinker to a mixture that includes the solvent and the surface active agent by pouring, spraying or electro-spinning the resin or resin mixture into the solvent.

In still further exemplary embodiments of the present invention, a method for manufacturing a thermoset material can be provided which may include, e.g.: (i) melting a thermosetting resin; (ii) adding a crosslinker to the molten thermosetting resin to obtain a partially crosslinked mixture; (iii) adding the partially crosslinked mixture to a solvent and a surface active agent to obtain a reaction mixture; (iv) completing crosslinking of the thermosetting resin in the reaction mixture to obtain a thermoset material; and (v) removing the solvent.

In yet further exemplary embodiments of the present invention, a method for manufacturing a thermoset material can be provided which may include, e.g.: (i) melting at least one thermosetting resin; (ii) adding the molten resin to a reaction mixture that includes a solvent and a surface active agent; (iii) adding a crosslinker to the reaction mixture; (iv) crosslinking the thermosetting resin in the reaction mixture to obtain a thermoset material; and (v) removing the solvent.

The reaction mixture used in exemplary embodiments of the present invention can have a form of a dispersion, a suspension or an emulsion. Crosslinking procedures that may be used can include polycondensation and/or polyaddition reactions. Surface active agents that may be used can include, e.g., a surfactant, an emulsifier, a dispersant, or mixtures or combinations thereof.

In certain exemplary embodiments of the present invention, the reaction mixture can include a rheology modifier. Other functional additives may also be used such as, e.g., catalysts, fillers, metal powders, metal compounds, clays, minerals, salts, polymers, etc. Such functional additives can be mixed into the thermosetting resin and/or a mixture of the thermosetting resin with a crosslinker. The thermosetting resin can include, but is not limited to, uncured or partially cured monomers, dimers, oligomers or prepolymers, natural or synthetic resins which can be modified or unmodified such as, e.g., phenolic resins, phenol-aldehyde resins, novolaks, epoxy novolaks, resols, resitols, phenol-novolak, xylene-novolak, cresol-novolak, or epoxy resins. Crosslinkers which may be used in accordance with exemplary embodiments of the present invention can include, e.g., aldehydes, polyfunctional aliphatic or aromatic amine including diamines such as phenyl diamine, ethyl diamine, hexamethylene tetraamine, isocyanates, etc.

In further exemplary embodiments of the present invention, a method for manufacturing spherical thermoset particles can be provided. Such particles can include an active agent such as, for example, a therapeutically active agent, a biologically active agent, a diagnostic agent, a catalyst, an enzyme, or living organism such as cells or microorganisms, or combinations thereof. These particles can also be used, e.g., as a support for culturing of cells and/or tissue in vivo or in vitro, as a scaffold for tissue engineering, optionally in a living organism or in a bioreactor, for producing a direct or indirect therapeutic effect in a mammal, for direct or indirect diagnostic purposes, or combinations thereof. Such particles may also be used as a catalyst support.

Thermoset-based particles formed in accordance with exemplary embodiments of the present invention can be formed using emulsion, dispersion and/or suspension polymerization techniques, or using spray or electro-spinning techniques. Such thermoset particles can be subjected to further processing by pyrolysis and/or carbonization treatments at high temperatures to produce glassy materials or carbon species.

These and other objects, features and advantages of the present invention will become apparent upon reading the following detailed description of embodiments of the invention, when taken in conjunction with the appended claims.

### BRIEF DESCRIPTION OF THE DRAWINGS

The foregoing and other objects of the present invention will be apparent upon consideration of the following detailed description, taken in conjunction with the accompanying drawings, in which:

FIG. 1 is an exemplary scanning electron microscopy (“SEM”) image of hollow thermoset particles produced in accordance with exemplary embodiments of the present invention;

FIG. 2 is an exemplary SEM image of a porous thermoset-based particle produced in accordance with exemplary embodiments of the present invention;

FIG. 3 is an exemplary SEM magnified image of the particle shown in FIG. 2 which includes an artificially produced opening in a wall of the particle;

FIG. 4 is an exemplary SEM image of a thermoset-based particle containing porous titanium oxide produced in accordance with exemplary embodiments of the present invention;

FIG. 5 is an exemplary graph showing a pore volume distribution of particles obtained in accordance with exemplary embodiments of the present invention; and

FIG. 6 is an exemplary graph showing release of paclitaxel over time from porous thermoset particles in accordance with exemplary embodiments of the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with the illustrative embodiments.

### DETAILED DESCRIPTION OF EXEMPLARY EMBODIMENTS OF THE INVENTION

In accordance with exemplary embodiments of the present invention, thermoset-based particles may be produced by utilizing polymerization techniques in liquid media such as, for example, emulsion, dispersion or suspension polymerization techniques. Emulsion, dispersion or suspension polymerization techniques may be used to economically produce thermoset particles, including spherical particles. Polymerization techniques used in accordance with certain embodiments of the present invention can allow for a tailoring of certain properties of the thermoset-based particles by adjusting material composition and/or process parameters in the manufacturing process. Such exemplary techniques can facilitate, e.g., control or alteration of specific mechanical, thermal, electrical, magnetical and/or optical properties of the thermoset particles produced.

Furthermore, both porous and non-porous spherical thermoset particles may be produced using exemplary emulsion, dispersion and suspension polymerization techniques described herein. Such particles can be further transformed using high temperatures to form, e.g., glassy porous or nonporous carbon-based particles. These particles may be used, for example, as molecular sieves, catalyst supports, sand-blasting materials, in bioprocessing applications as supports and carriers for cell cultures, and as drug-delivery particles for therapeutically and/or diagnostically active agents in pharmacology.

In accordance with exemplary embodiments of the present invention, a thermosetting resin may be dispersed in a suitable solvent or solvent mixture. The thermosetting resin can be prepared without the use of solvents by, for example, using a liquid state resin or liquefying the resin by melting it. Functional additives may be added to the resin, where the additives may have a liquid or a solid form or a mixture thereof. The thermosetting resin or the resin-additive blend or dispersion can then be added to a suitable solvent or solvent mixture to form a reaction mixture.

The reaction mixture can then be cured and/or crosslinked to form thermoset particles. A surface active agent, which may include a surfactant, an emulsifier or dispersant, can be provided in the solvent before the resin is added, and/or it may be added after or during addition of the thermosetting resin to the reaction mixture.

Curing agents and/or crosslinking agents may also be added to the reaction mixture before, during or after addition of the thermosetting resin. Curing or crosslinking of the thermosetting resin to form the thermoset particles may be performed by the application of a heat and/or radiation, or by any other suitable mechanism. After the thermoset particles are formed, they may be isolated from the reaction mixture, dried, and optionally washed.

The thermoset particles thus formed can optionally be further modified. For example, the thermoset particles may be subjected to a carbonization treatment at elevated temperatures as described herein, which can produce glassy and/or carbon-based particles.

A term “thermosetting resin” as used herein can include, e.g., any precursor which may be suitable for producing thermosetting plastics and/or thermosets such as, for example, monomers, oligomers or prepolymers made from natural or synthetic, modified or unmodified resins which are not fully cured and/or crosslinked, e.g., which can be capable of being further cured and/or crosslinked using, e.g., polycondensation or polyaddition reactions. Thermosetting resins can have a liquid form at ambient conditions or they may be melted at relatively low temperatures, for example, below 100° C., to form liquids, which can occur without significant decomposition of the resin. Examples of such resins can include, e.g., uncured or partially cured or crosslinked phenolic resins such as novolaks or resols, phenolaldehydes, urea-formaldehydes, epoxy resins, epoxy-novolak resins, amino resins, unsaturated polyester resins, alkyd resins, diallyl phthalat resins, etc., or combinations thereof.

Terms “thermosetting plastic,” “thermosetting polymer” and “thermoset” as used herein can be understood to refer to, e.g., non-thermoplastic materials which can be made from curable resins, e.g., from thermosetting resins, by performing curing and/or crosslinking reactions such as, for example, polycondensation and/or polyaddition reactions which may use suitable crosslinking or curing agents, respectively. Thermosets can be highly crosslinked materials which may not be capable of melting without decomposition. Examples of such materials can include, e.g., cured and/or crosslinked diallyl phthalat resins (DAP), epoxy resins (EP), urea-formaldehyde resins (UF), melamine-formaldehyde resins (MF), melamine-phenol-formaldehyde resins (MP), phenol-formaldehyde resins (PF) and saturated polyester resins (UP).

A term “polycondensation reaction” as used herein can include, e.g., a polymerization or curing/crosslinking mechanism, in which an elimination of a component may occur. For example, such a reaction can include water or some other simple substance separating from certain reacting molecules upon their combination.

A term “polyaddition reaction” as used herein can include, e.g., a polymerization or curing/crosslinking mechanism, in which molecules may be combined to form larger molecules without a production of by-products, e.g., without elimination of components. For example, the molecular weight of a product formed by a polyaddition reaction can be essentially equal to the total molecular weight of all of the combined reacting molecules.

Terms “curing” and “crosslinking” as used herein can be understood to refer to, e.g., reactions in which crosslinkers and thermosetting resins may react with each other to produce crosslinked structures of thermosets.

A term “surface active agent” as used herein can include, e.g., surfactants, emulsifiers, dispersants and other substances or materials which can act as such.

Polymerization

Methods in accordance with exemplary embodiments of the present invention can include a polymerization reaction for producing thermoset materials such as, e.g., particles which may be approximately spherical in shape. Such polymerization reactions can include polycondensation or polyaddition reactions. The reactions may be performed in liquid media, for example, in a heterogeneous liquid reaction mixture. Liquid-phase polymerization techniques such as, e.g., emulsion, dispersion or suspension polymerization, including mini-emulsion polymerization, which may be used to produce conventional thermoplastic materials, may also be used to produce essentially spherical particles made of thermosetting plastics as described herein.

A polymerization process used in accordance with exemplary embodiments of the present invention can include a polymerization reaction, which may further include a use of initiators, starters and/or catalysts which may be suitable for curing and/or cross-linking the thermosetting resin in a polycondensation and/or polyaddition reaction.

Emulsion, suspension or dispersion polymerization techniques which may be used in accordance with exemplary embodiments of the present invention are described in, for example, Australian Patent Publication No. AU 9169501, European Patent Publication Nos. EP 1205492, EP 1240215, EP 1401878 and EP 1352915, U.S. Pat. No. 6,380,281, U.S. Patent Publication No. 2004192838, Chinese Patent Publication No. CN 1262692T, Canadian Patent Publication No. CA 1336218, Great Britain Patent Publication No. GB 949722, and German Patent Publication No. DE 10037656. Such techniques are also described in, e.g., S. Kirsch et al., “Particle morphology of carboxylated poly-(n-butyl acrylate)/(poly(methyl methacrylate) composite latex particles investigated by TEM and NMR,” Acta Polymerica 1999, 50, 347-362; K. Landfester et al., “Evidence for the preservation of the particle identity in miniemulsion polymerization,” Macromol. Rapid Commun. 1999, 20, 81-84; K. Landfester et al., “Miniemulsion polymerization with cationic and nonionic surfactants: A very efficient use of surfactants for heterophase polymerization,” Macromolecules 1999, 32, 2679-2683; K. Landfester et al., “Formulation and stability mechanisms of polymerizable miniemulsions,” Macromolecules 1999, 32, 5222-5228; G. Baskar et al., “Comb-like polymers with octadecyl side chain and carboxyl functional sites: Scope for efficient use in miniemulsion polymerization,” Macromolecules 2000, 33, 9228-9232; N. Bechthold et al., “Miniemulsion polymerization: Applications and new materials,” Macromol. Symp. 2000, 151, 549-555; N. Bechthold et al., “Kinetics of miniemulsion polymerization as revealed by calorimetry,” Macromolecules 2000, 33, 4682-4689; B. M. Budhlall et al., “Characterization of partially hydrolyzed poly(vinyl alcohol). I. Sequence distribution via H-1 and C-13-NMR and a reversed-phased gradient elution HPLC technique,” Macromol. Symp. 2000, 155, 63-84; D. Columbie et al., “Competitive adsorption of the anionic surfactant Triton X-405 on PS latex particles,” Langmuir 2000, 16, 7905-7913; S. Kirsch et al., “Particle morphology of carboxylated poly-(n-butyl acrylate)/poly(methyl methacrylate) composite latex particles,” Macromol. Symp. 2000, 151, 413-418; K. Landfester et al., “Polyaddition in miniemulsions: A new route to polymer dispersions,” Macromol. Chem. Phys. 2000, 201, 1-5; K. Landfester, “Recent developments in miniemulsions—Formation and stability mechanisms,” Macromol. Symp. 2000, 150, 171-178; K. Landfester et al., “Preparation of polymer particles in non-aqueous direct and inverse miniemulsions,” Macromolecules 2000, 33, 2370-2376; K. Landfester et al., “The polymerization of acrylonitrile in miniemulsions: ‘Crumpled latex particles’ or polymer nanocrystals,” Macromol. Rapid Comm. 2000, 21, 820-824; B. z. Putlitz et al., “Vesicle forming, single tail hydrocarbon surfactants with sulfonium-headgroup,” Langmuir 2000, 16, 3003-3005; B. z. Putlitz et al., “New cationic surfactants with sulfonium-headgroup,” Langmuir 2000, 16, 3214-3220; J. Rottstegge et al., “Different types of water in film formation process of latex dispersions as detected by solid-state nuclear magnetic resonance spectroscopy,” Colloid Polym. Sci. 2000, 278, 236-244; M. Antonietti et al., “Single molecule chemistry with polymers and colloids: A way to handle complex reactions and physical processes?” Chem Phys Chem 2001, 2, 207-210; K. Landfester et al., “Heterophase polymerization in inverse systems,” in Reactions and Synthesis in Surfactant Systems, J. Texter, Ed., Marcel Dekker, Inc.: New York, 2001, pp 471-499; K. Landfester, “Polyreactions in miniemulsions,” Macromol. Rapid Comm. 2001, 896-936; K. Landfester, “The generation of nanoparticles in miniemulsion,” Adv. Mater. 2001, 10, 765-768; K. Landfester, “Chemie—Rezeptionsgeschichte,” in Der Neue Pauly—Enzyklopädie der Antike, Verlag J. B. Metzler: Stuttgart, 2001, Vol. 15; B. z. Putlitz et al., “The generation of ‘armored latexes’ and hollow inorganic shells made of clay sheets by templating cationic miniemulsions and latexes,” Adv. Mater. 2001, 13, 500-503; F. Tiarks et al., “Preparation of polymeric nanocapsules by miniemulsion polymerization,” Langmuir 2001, 17, 908-917; F. Tiarks et al., “Encapsulation of carbon black by miniemulsion polymerization,” Macromol. Chem. Phys. 2001, 202, 51-60; F. Tiarks et al., “One-step preparation of polyurethane dispersions by miniemulsion polyaddition,” J. Polym. Sci., Polym. Chem. Ed. 2001, 39, 2520-2524; and F. Tiarks et al., “Silica nanoparticles as surfactants and fillers for latexes made by miniemulsion polymerization,” Langmuir 2001, 17, 5775-5780.

Emulsion, dispersion or suspension used in accordance with exemplary embodiments of the present invention can have a form of an aqueous, non-aqueous, polar or non-polar liquid, which can be homogenous or heterogeneous. The polymerization reaction can be at least partially performed in the dispersion, emulsion or suspension including, for example, in a mini-emulsion. Solvents, surfactants and reaction conditions for curing and/or crosslinking the thermosetting resin in the reaction mixture to form the desired thermoset particles may be selected based on the thermosetting resin used.

Methods in accordance with certain exemplary embodiments of the present invention can include the steps of providing at least one thermosetting resin, at least one solvent, at least one surface active agent and at least one crosslinker, preparing a reaction mixture which includes these components, and cross-linking and/or curing the thermosetting resin in a polycondensation and/or polyaddition reaction to obtain thermoset material or particles. For example, the reaction mixture can include an emulsion, a mini-emulsion, a suspension or a dispersion of the thermosetting resin in the solvent.

The reaction mixture can be agitated or stirred using, e.g., conventional stirring equipment to disperse the thermosetting resin. The stirring equipment can provide, e.g., flow of the reaction mixture in the direction of stirring and an additional flow in a perpendicular direction. The thermosetting resin, which may be prepolymerized, can thus be introduced into a mixture of surfactant and solvent.

Exemplary embodiments of the present invention can provide a method for the manufacture of a thermoset material, wherein a reaction mixture can be provided which includes, e.g., at least one thermosetting resin, at least one crosslinker, at least one surface active agent, and at least one solvent. The thermosetting resin may then be crosslinked in the reaction mixture, and the resulting material may then be isolated, e.g., by removing the solvent from the reacted mixture.

For example, a crosslinker or a mixture of crosslinkers can be added to a thermosetting resin, and the combination may then be added to a liquid medium that includes, e.g., a solvent or a solvent mixture and a surface active agent, to form a reaction mixture. Functional additives such as, e.g., fillers, markers, catalysts, etc. may also be added to the thermosetting resin to produce thermoset particles containing these additives. Alternatively, the crosslinker can be added to the reaction mixture which includes the thermosetting resin. The thermosetting resin can be provided in a liquid state, e.g., in a solution or a molten state.

According to certain exemplary embodiments of the present invention, thermoset fibers can be obtained by preparing a reaction mixture which can include at least one thermosetting resin, at least one crosslinker, at least one surface active agent, and at least one solvent. The thermosetting resin can be at least partially crosslinked, and the reaction mixture can be electro-spun to produce thermoset fibers. In this exemplary process, curing or crosslinking of the thermosetting resin can be essentially completed while it is being squeezed through a heated electrospinning nozzle, whereby the solvent may also be evaporated. A reaction mixture having a high viscosity may be used for electrospinning. For example, suspensions comprising about 50 wt % of thermosetting resin and functional additives may be used, with the remainder of the suspension being solvent and surfactant. Solvents that may be used include, e.g., methylethyl ketone or methylisobutyl ketone, which may optionally be mixed with water. By adding certain functional additives to the thermosetting resin, a variety of fibrous materials based on thermoset polymers can be produced.

In a further exemplary embodiment of the present invention, the thermosetting resin can be provided in a molten form or in a solution with, e.g., acetone, methylisobutyl ketone or another suitable solvent. A crosslinker can then be added to the liquid thermosetting resin to provide a partially crosslinked mixture. Functional additives may be added to this mixture or to the thermosetting resin, if desired. The partially crosslinked mixture can then be added to a liquid medium, which can include at least one solvent and at least one surface active agent, to provide a reaction mixture wherein the thermosetting resin may be substantially completely crosslinked to produce a thermoset material. Such material can have a form of substantially spherical particles. The thermoset material can then be isolated by substantially removing the solvent, e.g., by filtration, and optionally drying and/or washing the thermoset material.

In a still further exemplary embodiment of the present invention the thermosetting resin, if not in a liquid form, can be melted or dissolved in a suitable solvent or solvent mixture, optionally mixed with one or several functional additives, and subsequently added to a liquid medium which can include at least one solvent and at least one surface active agent to form a reaction mixture. One or more crosslinkers may be added to the reaction mixture and the thermosetting resin can be substantially crosslinked in the reaction mixture, thereby producing a thermoset material. The solvent can then be substantially removed from the reacted mixture.

For example, the reaction mixture can be prepared by pouring, spraying or electro-spinning the thermosetting resin and/or a mixture of the resin with at least one crosslinker together with a liquid medium that includes at least one solvent and at least one surface active agent. The thermosetting resin can be mixed with functional additives and one or more cross-linkers, and this mixture can be introduced into a further mixture of a surfactant and a solvent, e.g., by pouring it into the stirred solvent mixture. Alternatively, the thermosetting resin mixture can be sprayed into the stirred solvent mixture using a nozzle, or by electrospinning fibers into the solvent mixture. The reaction mixture can also be processed, e.g., by electrospinning it to form fibers or solid particles.

Crosslinking of the thermosetting resin in the reaction mixture or in a prepolymerization procedure can be achieved, e.g., by the addition of initiators, by heating and/or by exposure to radiation. Thermosetting resin/crosslinker combinations can be used which are capable of reacting with each other when heated. For example, the thermosetting resin can be added to the solvent or solvent/surfactant mixture at a temperature below a critical temperature for the cross-linking reaction. The temperature of the reaction mixture may then be increased to a higher temperature, which can facilitate or lead to formation of thermosetting particles via a polycondensation and/or polyaddition reaction.

The reaction mixture can be provided at a temperature of, e.g., between about 60° C. and 400° C., or preferably between about 60° C. and 250° C., or more preferably between about 80° C. and 150° C. The temperature may be selected based on, e.g., the particular components of the mixture being used. To enhance or replace a thermal crosslinking reaction, crosslinking can be induced by ultraviolet (“UV”), gamma, or infrared (“IR”) radiation, visible light, laser radiation, or a combination thereof.

The reaction mixture may be provided in a form of an emulsion, a dispersion or a suspension, and it can be stirred for a time sufficient to essentially complete the polymerization reaction. The solvent can then be removed after the reaction has occurred.

In certain exemplary embodiments of the present invention, the polyaddition and/or polycondensation reaction can be initiated before the addition of a solvent by adding a cross-linker and/or curing agent to monomers or oligomers or prepolymers such as, e.g., novolak or epoxy-novolak materials. This exemplary technique can provide thermosetting resins in a form of higher molecular weight prepolymerisates, which may exhibit a higher viscosity and provide more viscous particle suspensions. Such resins can provide an increased yield for the process and may assist in the formation of particles in the suspension. For example, the degree of prepolymerization may be correlated with an increase in particle sizes during the final polymerization procedure. The yield of composite particles may also be increased, e.g., if prepolymerization is performed after the introduction of solid or liquid functional additives such as, e.g., metal oxide particles or liquid or solid porogens.

For example, the viscosity of the reaction mixture can be adjusted by adding rheology modifiers such as, e.g., alkylcelluloses, including methylcellulose, ethylcellulose, hydroxypropylmethylcellulose, etc. Addition of rheology modifiers can further influence particle sizes and yield of the thermoset material produced in the reaction mixture. A more viscous suspension can lead to formation of larger particles sizes and an increase in the overall yield.

Prepolymerization of oligomeric precursors such as, e.g., novolaks, epoxy-novolaks and resols or epoxy resins, can include a melting of the precursor with stirring, optional addition of a filler or other additives, and addition of a cross-linking agent to provide a prepolymerization resin. The prepolymerized thermosetting resin can then be introduced under agitation into a solvent or solvent mixture and dispersed therein to prepare a dispersion, emulsion or suspension, and further treated as described herein to produce thermoset particles. For example, agitation can be provided by stirring the reaction mixture using stirring equipment. The surface active agent may be present in the solvent or solvent mixture, or it can be added to the solvent mixture with or after addition of the prepolymer of the thermosetting resin.

Thermosetting Resins

Thermosetting resins used in accordance with exemplary embodiments of the present invention can include, e.g., monomers, oligomers or prepolymers of natural or synthetic resins which may be modified or unmodified, or combinations thereof. Such thermosetting resins can include various substances which may be capable of undergoing a condensation and/or addition reaction to form crosslinked thermosetting plastics. Monomers may be partially prepolymerized to obtain partially cured and/or crosslinked oligomeric or prepolymeric thermosetting resins, which may then be dispersed in the reaction mixture.

Examples of thermosetting resins can include, e.g., uncured or partially cured and/or crosslinked phenolic resins such as novolaks or resols, phenolaldehydes, urea-formaldehydes, epoxy resins, epoxy-novolak resins, amino resins, unsaturated polyester resins, alkyd resins, diallyl phthalat resins, etc., and combinations thereof.

Thermosetting resins can include, e.g., phenolic resins prepared by reacting an aldehyde or ketone with a phenolic compound. The phenolic compound can include, e.g., phenol, C1-C15-mono- or dialkyl phenols such as o-, m-, or p-cresol, m- or p-dimethylphenol, octylphenol, nonylphenol, dodecylphenol, pyrocatechol, resorcinol, hydroquinone, pyrogallol, phloroglucinol, aryl phenols such as phenylphenol, bisphenols such as bisphenol A, bisphenol B, bisphenol F or bisphenol S, 1-naphthol, 2-naphthol, naphthoresorcinol, or mixtures, combinations and/or modified forms thereof. Aldehydes can include, for example, formaldehyde, paraldehyde, formaldehyde releasing compounds such as hexamethylene tetraamine, acetaldehyde, benzaldehyde, acrolein, or mixtures thereof.

For example, novolaks having a molecular weight of about 400 to 5000 g/mol, which may be prepared from substituted or unsubstituted phenols and formaldehyde, can be used. Resols which may be prepared from phenols and formaldehyde in a base catalyzed reaction with a molar excess of formaldehyde can also be used as thermosetting resins. For example, the thermosetting resin can be a phenolic resin prepared by an addition reaction between a phenol or a phenolic compound and an unsaturated compound which can include, e.g., acetylene, terpenes or resins of natural origin such as, e.g., rosin or rosin derivatives.

Exemplary thermosetting resins can also include unsaturated polyesters, including alkyd resins. Such polyesters can contain polymer chains having various numbers of saturated or aromatic dibasic acids and anhydrides such as, e.g., phthalic acid, succinic acid, maleic acid, maleic acid anhydrid, glycerol, trimethylolpropane, pentaerythritol, etc.

Further examples of thermosetting resins can include alkyd resins prepared from a condensation reaction between at least one multifunctional alcohol and at least one diacid or acid anhydride which can include, e.g., phthalic acid, maleic acid, succinic acid, their anhydrides or any combinations thereof. Polyallyl resins prepared, e.g., from diallyl phthalate or triallylcyanurate may also be used.

For example, the thermosetting resin can include an amino resin prepared by reacting an aldehyde or ketone with an amino group containing a compound such as, e.g., urea, melamine, or a mixture of melamine and phenol. Such amino resins can include melamine resins, melamine-phenol-formaldehyde resins, urea resins formed from substituted or unsubstituted urea, urethane resins, cyanamide resins, dicyanamide resins, anilin resins, sulfonamide resins, etc., and combinations thereof. Aldehydes which may be used include, e.g., formaldehyde, paraldehyde, formaldehyde-releasing compounds, acetaldehyde, benzaldehyde, acrolein, or mixtures thereof.

Resins which may be used in exemplary embodiments also include, e.g., epoxy resins and monomers, oligomers or polymers which may contain one or a plurality of oxiran rings, and which may also include an aliphatic, aromatic or mixed aliphatic-aromatic molecular structure, or which may have an aliphatic or cycloaliphatic structure with or without substituents such as, e.g., halogens, ester groups, ether groups, sulfonate groups, siloxane groups, nitro groups or phosphate groups, or combinations thereof.

The thermosetting resin can be an oligomeric or prepolymeric epoxy resin or a derivative thereof, an aliphatic, cycloaliphatic, aromatic or heterocyclic epoxy resin including, e.g., combined phenolic and epoxy resins such as epoxy-phenol-novolak or epoxy-resol-novolak, and mixtures or combinations thereof. Suitable epoxy resins and epoxy-novolaks can include, for example, materials sold by Dow Chemical under the D.E.R.® and D.E.N.® designations, including D.E.N.® 438.

In further exemplary embodiments of the present invention, the thermosetting resin can be an epoxy resin prepared, e.g., by reacting epichlorhydrin with a hydroxy compound, including dihydroxy compounds such as, e.g., bisphenol A, bisphenol B, bisphenol F, bisphenol S, 1-naphthol, 2-naphthol, naphthoresorcinol, C1-C15-mono- or di-alkyl phenols such as o-, m-, or p-cresol, m- or p-dimethylphenol, octylphenol, nonylphenol, dodecylphenol; pyrocatechol, resorcinol, hydroquinone, pyrogallol, phloroglucinol, aryl phenols such as phenylphenol, phenol-novolak, cresol-novolak, a resol, a resitol, or mixtures, combinations and/or modified forms thereof.

For example, thermosetting resins can include, but are not limited to, epoxy resins of the glycidyl-epoxide type, for example those having diglycidylether groups of bisphenol-A, amino derivatized epoxy resins such as, e.g., tetraglycidyldiaminodiphenylmethane, triglycidyl-p-aminophenol, triglycidyl-m-aminophenol or triglycidylaminocresol and their isomers, phenol derivatized epoxy resins such as, e.g., bisphenol-A epoxy resin, bisphenol-F epoxy resin, bisphenol-S epoxy-resin, phenol-novolak-epoxy resin, cresol-novolak-epoxyresin or resorcinol epoxy resin, or alicyclic epoxy resins. Halogenated epoxy resins may also be used such as, e.g., glycidylether of polyhydric phenols, diglycidylether of bisphenol A, glycidylethers of phenol-formaldehyde novolak resins and resorcinol-digylcidylether, or other epoxy resins such as those described in U.S. Pat. No. 3,018,262.

Thermosetting resins which may be used with exemplary embodiments of the present invention can include, for example, mixtures of two or three epoxy resins or mono-epoxy components, UV-cross-linkable resins or cycloaliphatic resins, silicone resins based on polydimethylsiloxanes and their derivatives, or polyurethanes.

Solvents

A solvent or solvent mixture which may be used in preparing a reaction mixture in accordance with exemplary embodiments of the present invention can be selected based on properties of surfactants and thermosetting resins used. Such solvents may be, e.g., aqueous, non-aqueous, polar or non-polar.

For example, suitable solvents can include water, nonpolar or polar solvents, alcohols, methanol, ethanol, N-propanol, isopropanol, butoxydiglycol, butoxyethanol, butoxyisopropanol, butoxypropanol, n-butyl alcohol, t-butyl alcohol, butylene glycol, butyl octanol, diethylene glycol, dimethoxydiglycol, dimethyl ether, dipropylene glycol, ethoxydiglycol, ethoxyethanol, ethyl hexane diol, glycol, hexane diol, 1,2,6-hexane triol, hexyl alcohol, hexylene glycol, isobutoxy propanol, isopentyl diol, 3-methoxybutanol, methoxydiglycol, methoxyethanol, methoxyisopropanol, methoxymethylbutanol, methoxy PEG-10, methylal, methyl hexyl ether, methyl propane diol, neopentyl glycol, PEG-4, PEG-6, PEG-7, PEG-8, PEG-9, PEG-6-methyl ether, pentylene glycol, PPG-7, PPG-2-buteth-3, PPG-2 butyl ether, PPG-3 butyl ether, PPG-2 methyl ether, PPG-3 methyl ether, PPG-2 propyl ether, propane diol, propylene glycol, propylene glycol butyl ether, propylene glycol propyl ether, tetrahydrofurane, trimethyl hexanol, phenol, benzene, toluene, xylene, alkylamines such as, e.g., methylamine, ethylamine, dimethylamine, diethylamine or higher homologues thereof, monoethanol amine, diethanolamine, triethanolamine, and mixtures of these substances.

Surface Active Agents

Reaction mixtures used in exemplary embodiments of the present invention can include a surface active agent, or a mixture or combination of such agents. Surface active agents can include conventional surfactants, emulsifiers or dispersants, including those suitable for suspension-, emulsion- or dispersion-polymerization techniques. Such surface active agents can be used to disperse, emulsify or suspend the thermosetting resin within the reaction mixture, for example, in a form of small droplets or micelles. Surface active agents can be compounds capable of emulsifying or suspending hydrophobic thermosetting resins when using hydrophilic solvents such as, e.g., water or lower alcohols. Surface active agents may be added to the reaction mixture before introducing the thermosetting resin, or they may be added to a mixture that includes the thermosetting resin and the solvent. A portion of the surface active agent may be dispersed in the solvent before adding the thermosetting resin to the reaction mixture. For example, the thermosetting resin can be introduced into a mixture that includes the solvent and surface active agent.

Surface active agents can further allow for an adjustment of the amount and/or size of the emulgated or dispersed droplets of thermosetting resins in the dispersion, emulsion or suspension. The amount of a surface active agent used in the reaction mixture in accordance with exemplary embodiments of the present invention may be adjusted based on the combination of solvent and thermosetting resin used to provide sufficient dispersion of the thermosetting resin in the reaction mixture. The type and amount of the surface active agent may also be selected to provide a particular size or size range of droplets formed from the thermosetting resin in the reaction mixture.

A higher surface active agent concentration in the reaction mixture can provide smaller droplets dispersed therein, and may thereby produce smaller thermoset particles. Larger thermosetting resin droplets may be present, e.g., if the thermosetting resin and/or the reaction mixture is highly viscous.

Surface active agents used in methods in accordance with exemplary embodiments of the present invention can be provided, e.g., in a range of about 0.1 to about 10 wt %, or preferably about 0.5 to 5 wt %, where the weight percent can be expressed relative to the amount of thermosetting resin used.

Surface active agents can include, e.g., anionic, cationic, zwitterionic or non-ionic surfactants or emulsifiers or combinations thereof. For example, anionic surfactants or emulsifiers can include soaps, alkylbenzolsulfonates, alkansulfonates, olefinsulfonates, alkyethersulfonates, glycerinethersulfonates, α-methylestersulfonates, sulfonated fatty acids, alkylsulfates, fatty alcohol ether sulfates, glycerine ether sulfates, fatty acid ether sulfates, hydroxyl mixed ether sulfates, monoglyceride(ether)sulfates, fatty acid amide(ether)sulfates, mono- and di-alkylsulfosuccinates, mono- and di-alkylsulfosuccinamates, sulfotriglycerides, amidsoaps, ethercarboxylic acid and their salts, fatty acid isothionates, fatty acid arcosinates, fatty acid taurides, N-acylaminoacids such as, e.g., acyllactylates, acyltartrates, acylglutamates and acylaspartates, alkyloligoglucosidsulfates, protein fatty acid condensates, plant derived products based on wheat, and alkyl(ether)phosphates.

Cationic surfactants or emulsifiers which may be used to encapsulate the thermosetting resin can include, e.g., quaternary ammonium compounds such as dimethyldistearyl [symbol] ammoniumchloride, Stepantex® VL 90 (Stepan), esterquats, including quaternized fatty acid trialkanolaminester salts, salts of long-chain primary amines, quaternary ammonium compounds such as hexadecyltrimethyl-ammoniumchloride (CTMA-Cl), Dehyquart® A (cetrimonium [symbol] chloride, Cognis), or Dehyquart® LDB 50 (lauryldimethylbenzyl [symbol] ammonium [symbol] chloride, Cognis).

Surfactants or emulsifiers can also include, but are not limited to, lecithin, poloxamers, e.g., block copolymers of ethylene oxide and propylene oxide such as those available from BASF Co. under the tradename pluronic® including pluronic® F68NF, siloxane-based surfactants such as Alkoholethoxylate which may be available from the TWEEN® series provided by Sigma or Krackeler Scientific Inc., polyfunctional alcohols such as, e.g., polyvinylalcohol, polyethylenglycol etc.

Crosslinkers/Curing Agents

The type and amount of a cross-linker which may be added to the monomers or the molten or dissolved thermosetting resin or oligomer mixture prior to polymerization can affect the extent of cross-linking in the prepolymer and may permit an adjustment of the properties of the thermoset particles produced. For example, a thermosetting resin which includes a prepolymer having a high molecular weight can result in formation of less-porous thermoset particles and/or formation of larger particles within a narrow particle size distribution. The amount and type of cross-linkers used can also affect the overall reaction time.

Crosslinking agents may be added to the reaction mixture before, during or after dispersing the thermosetting resin therein. When a prepolymerization step is used as described herein, the crosslinkers added to the reaction mixture may be the same type as those used in the prepolymerization step. Different crosslinkers may also be used for the prepolymerization and polymerization steps.

The reaction mixture may be free of any crosslinker if, for example, thermosetting resins are provided which can be substantially fully cured using thermal or radiation treatments to produce the thermoset particles.

Particular crosslinkers and/or curing agents can be selected based on the type of thermosetting resins or monomers, oligomers or prepolymers thereof. For example, crosslinkers can include compounds capable of forming two- or three-dimensional networks when reacting with thermosetting resins. Multifunctional crosslinkers, e.g., crosslinkers having two or more functional groups per molecule which can react with functional groups associated with a backbone of the thermosetting resin, may be used to produce a highly crosslinked network.

Exemplary crosslinkers can include aldehydes and ketones, multifunctional alcohols, multifunctional amines and di-carboxylic acids or acid anhydrides, isocyanates, silanes, diols, (meth)acrylates such as, for example, 2-hydroxyethyl methacrylate, propyltrimethoxysilane, 3-(trimethylsilyl)propyl methacrylate, isophoron diisocyanate, dicyandiamide, diamino diphenyl sulfone, polyols, glycerine, etc., and combinations of these substances. Further examples of crosslinkers which may be used in certain exemplary embodiments of the present invention include aliphatic or aromatic di- and triamine compounds such as, for example, phenylene diamine, ethylene diamine, diethyltoluene diamine, etc. Such compounds can be used, for example, with epoxy resins or epoxy-novolaks.

Functional Additives

Certain properties of thermoset particles, e.g., mechanical stress resistance, electrical conductivity, impact strength, magnetic properties or optical properties, can be varied by addition of particular amounts and types of additives, e.g., to the thermosetting resin.

Functional additives can include, e.g., additives which may be substantially incorporated into the thermoset material produced using the exemplary methods described herein. Functional additives may be distinguished from additives which can be, e.g., added to the reaction mixture to affect process control such as rheology modifiers, surface active agents, dispersants etc. Although such process control additives may be partially incorporated into a thermoset material, they may have an insubstantial effect on the material properties, in contrast to the effects of functional additives.

Exemplary functional additives can include, for example, fillers, plasticizers, lubricants, flame resistants, pore-forming agents or porogens, metals and metal powders, silicon, silicon oxides, zeolites, titanium oxides, zirconium oxides, aluminum oxides, aluminum silicates, talcum, graphite, glass or glass fibers, carbon fibers, fullerenes, nanotubes, soot, phyllosilicates and the like, or mixtures thereof. For example, fillers which can be used as inorganic functional additives may include clays, minerals, kaolin, silicon oxides and aluminum oxides, aluminosilicates, zeolites, zirconium oxides, titanium oxides, talc, graphite, carbon black, fullerenes, phyllosilicates, suicides, nitrides, or combinations of such substances. Further examples of functional additives include metal powders such as, e.g., those of catalytically active transition metals such as copper, gold and silver, titanium, zirconium, hafnium, vanadium, niobium, tantalum, chromium, molybdenum, tungsten, manganese, rhenium, iron, cobalt, nickel, ruthenium, rhodium, palladium, osmium, iridium or platinum.

Metals or metal oxides which may be used as fillers can also be magnetic such as, e.g., iron, cobalt, nickel, manganese or mixtures thereof, including iron-platinum mixtures or iron oxide and ferrite. The use of magnetic fillers can provide magnetic properties to the thermoset particles, e.g., for use as electro-rheological compounds. Such additives may also be, e.g., super-paramagnetic, ferromagnetic or ferrimagnetic, including magnetic metal alloys, ferrites such as gamma iron oxide, magnetites or cobalt-, nickel- or manganese-ferrites. Such functional additives can include those described, e.g., in International Patent Publication Nos. WO83/03920, WO83/01738, WO85/02772, WO88/00060, WO89/03675, WO90/01295 and WO90/01899, and in U.S. Pat. Nos. 4,452,773, 4,675,173 and 4,770,183.

In certain exemplary embodiments of the present invention, functional additives may include, e.g., zero-valent metals, metal powders, metal compounds, metal alloys, metal oxides, metal carbides, metal nitrides, metal oxynitrides, metal carbonitrides, metal oxycarbides, metal oxynitrides, metal oxycarbonitrides, organic or inorganic metal salts, including salts of alkaline and/or alkaline earth metals and/or transition metals such as, e.g., alkaline or alkaline earth metal carbonates, sulfates, sulfites, semiconductive metal compounds, including those of transition and/or main group metals; metal based core-shell nanoparticles, glass or glass fibers, carbon or carbon fibers, silicon, silicon oxides, zeolites, titanium oxides, zirconium oxides, aluminum oxides, aluminum silicates, talcum, graphite, soot, flame soot, furnace soot, gaseous soot, carbon black, lamp black, minerals, phyllosilicates, or any mixtures thereof.

For example, functional additives may include magnetic, superparamagnetic, ferromagnetic, or ferromagnetic metal or alloy particles comprising iron, cobalt, nickel, manganese or mixtures thereof, iron-platinum mixtures or alloys, or magnetic metal oxides such as iron oxide, gamma-iron oxide, magnetites, and ferrites such as cobalt-, nickel- or manganese ferrites.

Semiconducting materials may be used as functional additives including, for example, semiconductors from Groups II and VI, Groups III and V, and/or Group IV. Group II and VI semi-conductors may include, for example, MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, HgTe, or mixtures thereof. Group III and V semiconductors may include, for example, GaAs, GaN, GaP, GaSb, InGaAs, InP, InN, InSb, InAs, AlAs, AIP, AISb, AIS and mixtures thereof. Group IV semi-conductors can include germanium, lead or silicon. Semiconductor functional additives may also include mixtures of semiconductors from more than one group or group combination listed herein.

Complex-structured metal-based particles may also be used as functional additives. For example, “core-shell configurations” may be used such as those described in Peng et al., “Epitaxial Growth of Highly Luminescent CdSe/CdS Core/Shell Nanoparticles with Photostability and electronic Accessibility,” Journal of the American Chemical Society, 119:7019-7029 (1997).

In certain exemplary embodiments of the present invention, core-shell configurations can include semiconducting nanoparticles which may have a core with a diameter of about 1 to 30 nm, or preferably about 1 to 15 nm, upon which further semi-conducting nanoparticles may crystallize to form a shell of about 1 to 30 monolayers, or preferably about 1 to 15 monolayers. The core and shell may be present in any combination of the materials listed herein including, e.g., core-shell configurations having CdSe and/or CdTe as the core and CdS or ZnS as the shell.

Materials which can be used as functional additives may have absorption properties for radiation in a wavelength region between and including gamma radiation and microwave radiation, and also may be capable of emitting radiation, for example in a region of 60 nm or less. Such materials can be provided, e.g., in a core-shell configuration, where particle sizes and core and shell diameters of such particles may be selected, e.g., to provide emission of light quanta having wavelengths between about 20 and 1,000 nm. Mixtures of such particles may be selected which can emit light quanta at different wavelengths when exposed to radiation. For example, such nanoparticles may be fluorescent, and may also fluoresce without any quenching.

Organic functional additives may also be used such as, for example, polymers, oligomers or pre-polymers; organometallic compounds, metal alkoxides, carbon particles including soot, lamp black, flame soot, furnace soot, gaseous soot, carbon black, etc., or carbon-containing nanoparticles and mixtures thereof, fullerenes such as C36, C60, C70, C76, C80, C86, C112, etc., nanotubes such as MWNT, SWNT, DWNT or randomly-oriented nanotubes, as well as fullerene onions, metallo-fullerenes, metal containing endohedral fullerenes and/or endometallofullerenes, including those of rare earth metals such as, e.g., cerium, neodymium, samarium, europium, gadolinium, terbium, dysprosium or holmium. Cotton or fabrics may also be used as functional additives, as well any combinations of the substances listed herein above.

Polymers, oligomers or pre-polymers that may be used as functional additives can include homopolymers or copolymers of aliphatic or aromatic polyolefins such as, e.g., polyethylene, polypropylene, polybutene, polyisobutene or polypentene, polybutadiene, polyvinyls such as polyvinyl chloride or polyvinyl alcohol, poly(meth)acrylic acid, polymethylmethacrylate (PMMA), polyacrylocyano acrylate, polyacrylonitril, polyamide, polyester, polyurethane, polystyrene, polytetrafluoroethylene, biopolymers such as collagen, albumin, gelatine, hyaluronic acid, starch or celluloses such as methylcellulose, hydroxypropyl cellulose, hydroxypropyl methylcellulose or carboxymethylcellulose phthalate, casein, dextranes, polysaccharides, fibrinogen, poly(D,L-lactides), poly(D,L-lactide coglycolides), polyglycolides, polyhydroxybutylates, polyalkyl carbonates, polyorthoesters, polyesters, polyhydroxyvaleric acid, polydioxanones, polyethylene terephthalates, polymaleate acid, polytartronic acid, polyanhydrides, polyphosphazenes, polyamino acids; polyethylene vinyl acetate, silicones, poly(ester urethanes), poly(ether urethanes), poly(ester ureas), polyethers such as polyethylene oxide, polypropylene oxide, pluronics, polytetramethylene glycol, polyvinylpyrrolidone, poly(vinyl acetate phthalate), shellac, and combinations of such homopolymers or copolymers. Such functional additives may be provided in a form of solutions, dispersions or suspensions, with or without solvents, in a solid form as fibers or particles, or in any combinations thereof.

Biopolymers may also be used to render the thermoset particles more biocompatible, e.g., for use as support materials in bioprocessing or as drug delivery materials. Hydrocarbon polymers such as polyolefines, paraffins, etc. may be incorporated into thermoset particles as porogens or pore-formers, which can provide porosity in the thermoset material during a carbonization or pyrolysis procedure, because such polymers may be substantially completely gasified. Such procedures can be used to produce, e.g., molecular sieve materials and porous drug delivery devices. The type and amount of such porogens used can affect pore size distribution and overall porosity in thermoset particles.

In certain embodiments of the present invention, functional additives may be used that include a mixture of at least one inorganic material and at least one organic material.

Functional additives such as those listed herein above can be provided in a form of particles having an essentially spherical or spheroidal shape. Such particles can have an average particle size between about 1 nm and 1,000 μm, or preferably between about 1 nm and 300 μm, or more preferably between about 1 nm and 6 μm. Such particle sizes can be used for any of the functional additive materials listed herein above.

Functional additives can also be provided in a form of tubes, fibers, fibrous materials or wires, including nanowires. Examples of such additives can include carbon fibers, nanotubes, glass fibers, and metal nano- or micro-wires. Such functional additives can have an average length between about 5 nm and 1,000 μm, preferably between about 5 nm and 300 μm, more preferably between about 5 nm and 20 μm, or even more preferably between about 2 and 20 μm, and an average diameter between about 1 nm to 1 μm, preferably between about 1 nm and 500 nm, more preferably between about 5 nm and 300 nm, and even more preferably between about 10 and 200 mm.

Functional additives may be modified, e.g., to improve their dispersion properties in resins or reaction mixtures, and/or to generate additional functional properties. For example, functional additives can be modified using silane compounds such as tetraalkoxysilanes, e.g., tetramethoxysilane (TMOS), tetraethoxysilane (TEOS) or tetra-n-propoxysilane, as well as oligomeric forms thereof, where the alkoxy may be branched or straight-chained and may contain about 1 to 25 carbon atoms. Such additives may also be modified using, e.g., alkylalkoxysilanes, where an alkyl group may be a substituted or unsubstituted, branched or straight-chain alkyl having about 1 to 25 carbon atoms. Such silane compounds can include, for example, methyltrimethoxysilane (MTMOS), methyltriethoxysilane, ethyltriethoxysilane, ethyltrimethoxysilane, methyltripropoxysilane, methyltributoxysilane, propyltrimethoxysilane, propyltriethoxysilane, isobutyltriethoxysilane, isobutyltrimethoxy-silane, octyltriethoxysilane, octyltrimethoxysilane or phenyltriethoxysilane (which can be obtained from Degussa AG, Germany), methacryloxydecyltrimethoxysilane (MDTMS); aryltrialkoxysilanes such as phenyltrimethoxysilane (PTMOS), phenyltripropoxysilane, phenyltributoxysilane, phenyl-tri-(3-glycidyloxy)-silane-oxide (TGPSO), 3-aminopropyltrimethoxysilane, 3-aminopropyl-triethoxysilane, 2-aminoethyl-3-aminopropyltrimethoxysilane, 3-aminopropylmethyl-diethoxysilane, triaminofunctional propyltrimethoxysilane (Dynasylan® TRIAMO, which can be obtained from Degussa AG, Germany), N-(n-butyl)-3-aminopropyltrimethoxysilane, 3-glycidyloxypropyltrimethoxysilane, 3-glycidyloxypropyltriethoxy-silane, vinyltrimethoxysilane, vinyltriethoxysilane, 3-mercaptopropyltrimethoxy-silane, Bisphenol-A-glycidylsilanes, (meth)acrylsilanes, phenylsilanes, oligomeric or polymeric silanes, epoxysilanes, fluoroalkylsilanes such as, e.g., fluoroalkyltrimethoxysilanes, fluoroalkyltriethoxysilanes having a partially or fully fluorinated, straight-chain or branched fluoroalkyl residue with about 1 to 20 carbon atoms such as, e.g. tridecafluoro-1,1,2,2-tetrahydrooctyltriethoxysilane, modified reactive flouroalkylsiloxanes (available from Degussa AG under the trademarks Dynasylan® F8800 and F8815), and mixtures of these compounds. Other compounds which may be used as functional additives include, e.g., 6-amino-1-hexanol, 2-(2-aminoethoxy)ethanol, cyclohexyl-amine, butyric acid cholesterylester (PCBCR), 1-(3-methoxycarbonyl)-propyl)-1-phenylester or combinations thereof. Such modification agents may also be used as crosslinkers.

Functional additives can include particles or fibers made from polymers, oligomers or pre-polymeric particles. Such particles may be prepared using conventional polymerization techniques capable of producing discrete particles such as, e.g., polymerizations in liquid media in emulsions, dispersions, suspensions or solutions, or the particles or fibers may be produced by extrusion, spinning, pelletizing, milling or grinding of polymeric materials.

In certain embodiments of the present invention, functional additives may include, for example, mono(meth)acrylate-, di(meth)acrylate-, tri(meth)acrylate-, tetra-acrylate and pentaacrylate-based poly(meth)acrylates. Mono(meth)acrylates can include, e.g., hydroxyethyl acrylate, hydroxyethyl methacrylate, hydroxypropyl methacrylate, hydroxypropyl acrylate, 3-chloro-2-hydroxypropyl acrylate, 3-chloro-2-hydroxypropyl methacrylate, 2,2-dimethylhydroxypropyl acrylate, 5-hydroxypentyl acrylate, diethylene glycol monoacrylate, trimethylolpropane monoacrylate, pentaerythritol monoacrylate, 2,2-dimethyl-3-hydroxypropyl acrylate, 5-hydroxypentyl methacrylate, diethylene glycol monomethacrylate, trimethylolpropane monomethacrylate, pentaerythritol monomethacrylate, hydroxy-methylated N-(1,1-dimethyl-3-oxobutyl)acrylamide, N-methylolacrylamide, N-methylolmethacrylamide, N-ethyl-N-methylolmethacrylamide, N-ethyl-N-methylolacrylamide, N,N-dimethylol-acrylamide, N-ethanolacrylamide, N-propanolacrylamide, N-methylolacrylamide, glycidyl acrylate, glycidyl methacrylate, methyl acrylate, ethyl acrylate, propyl acrylate, butyl acrylate, amyl acrylate, ethylhexyl acrylate, octyl acrylate, t-octyl acrylate, 2-methoxyethyl acrylate, 2-butoxyethyl acrylate, 2-phenoxyethyl acrylate, chloroethyl acrylate, cyanoethyl acrylate, dimethylaminoethyl acrylate, benzyl acrylate, methoxybenzyl acrylate, furfuryl acrylate, tetrahydrofurfuryl acrylate or phenyl acrylate. Di(meth)acrylates can include, but are not limited to, 2,2-bis(4-methacryloxyphenyl)propane, 1,2-butanediol-diacrylate, 1,4-butanediol-diacrylate, 1,4-butanediol-dimethacrylate, 1,4-cyclohexanediol-dimethacrylate, 1,10-decanediol-dimethacrylate, diethylene-glycol-diacrylate, dipropyleneglycol-diacrylate, dimethylpropanediol-dimethacrylate, triethyleneglycol-dimethacrylate, tetraethyleneglycol-dimethacrylate, 1,6-hexanediol-diacrylate, neopentylglycol-diacrylate, polyethyleneglycol-dimethacrylate, tripropyleneglycol-diacrylate, 2,2-bis[4-(2-acryloxyethoxy)-phenyl]propane, 2,2-bis[4-(2-hydroxy-3-methacryloxypropoxy)-phenyl]propane, bis(2-methacryloxyethyl)N,N-1,9-nonylene-biscarbamate, 1,4-cycloheanedimethanol-dimethacrylate or diacrylic urethane oligomers. Tri(meth)acrylates can include, e.g., tris(2-hydroxyethyl)isocyanurate-trimethacrylate, tris(2-hydroxyethyl)isocyanurate-triacrylate, trimethylolpropane-trimethacrylate, trimethylolpropane-triacrylate or pentaerythritol-triacrylate. Tetra(meth)acrylates can include pentaerythritol-tetraacrylate, di-trimethylopropan-tetraacrylate or ethoxylated pentaerythritol-tetraacrylate. Penta(meth)acrylates can include, e.g., dipentaerythritol-pentaacrylate or pentaacrylate-esters. Mixtures, copolymers and combinations of these substances may also be used.

Polymer particles or fibers may be used as functional additives, for example, oligomers or elastomers such as polybutadiene, polyisobutylene, polyisoprene, poly(styrene-butadiene-styrene), polyurethanes, polychloroprene, or silicone, or mixtures, copolymers and combinations of these substances.

Functional additives can also include particles or fibers made of electrically conducting polymers such as, e.g., saturated or unsaturated polyparaphenylene-vinylene, polyparaphenylene, polyaniline, polythiophene, poly(ethylenedioxythiophene), polydialkylfluorene, polyazine, polyfurane, polypyrrole, polyselenophene, poly-p-phenylene sulfide, polyacetylene, monomers oligomers or polymers thereof, and any combinations or mixtures thereof which may be formed with other monomers, oligomers or polymers or copolymers made of the monomers listed herein above. Such monomers, oligomers or polymers can include one or several organic groups such as, for example, alkyl- or aryl-radicals, etc., or inorganic radicals such as, e.g., silicon or germanium, or any mixtures thereof. Functional additives may also include conductive or semi-conductive polymers which can exhibit, e.g., an electrical resistance between 10¹² and 10⁵ Ohm-cm, or such polymers which include complexed metal salts.

Functional additives can also include, for example, inorganic metal salts, e.g., salts from alkaline and/or alkaline earth metals such as alkaline or alkaline earth metal carbonates, sulfates, sulfites, nitrates, nitrites, phosphates, phosphites, halides, sulfides, oxides, or mixtures thereof. Organic metal salts may also be used as fillers, including alkaline, alkaline earth and/or transition metal salts such as, e.g., formiates, acetates, propionates, malates, maleates, oxalates, tartrates, citrates, benzoates, salicylates, phthalates, stearates, phenolates, sulfonates, and amines, as well as mixtures thereof.

Pore forming agents can be used as functional additives including, e.g., an organic or organic salts, carbonates, fatty acids, lipids, paraffin, polyethylene glycol, polyethylene oxide, wax, etc., or mixtures of these substances. Pore formation can occur during the polymerization reaction, or after polymerization. Pores may be formed by leaching and washing out of incorporated salts in an optional functional processing procedure. Pores may also be formed during a subsequent heat treatment process. For example, pores can be formed by thermal degradation of the thermoset-based particles.

Functional additives such as those listed herein may be added into the reaction mixture. Alternatively, they may be added to the thermosetting resin during a prepolymerization step before the resin is added to the reaction mixture, which can provide improved incorporation of such additives into the thermosetting resin and improved process control. For example, an overall process time may be shorter, and less surfactant may be used to produce stable droplet suspensions or emulsions.

Isolation

Solvent that may be present in the reaction mixture can be removed after completion of the polymerization reaction, for example, by filtration, evaporation or other conventional techniques. The thermoset particles may be dried, and they may then optionally be washed and dried again. Drying can be performed using conventional techniques such as, e.g., application of elevated temperatures, exposing the particles to moving air or other gases which may optionally be heated, and exposing the particles to reduced pressure or a vacuum. The particles may be flushed with a further solvent or solvent mixture to wash them, which can remove impurities which may be present.

Particles which may be obtained using methods according to exemplary embodiments of the present invention described herein may have a particle size distribution. The width of such a distribution can vary with, e.g., the materials and the reaction conditions used. For example, a narrow particle size distribution may be obtained, e.g., by selecting certain concentrations of components and types of surface active agents, and by adjusting process parameters such as, e.g., temperature, viscosity, agitation of the reaction mixture, etc. After thermoset particles are formed and isolated, they may be classified or sorted using conventional screening or sieving operations, and/or they may be further processed, for example, using mechanical treatments such as grinding, thermal treatments such as carbonization or pyrolysis, etc.

Use of Thermoset Particles

Thermoset-based materials produced in accordance with exemplary embodiments of the present invention may be used, e.g., as fillers or sand-blasting materials. Such thermoset materials may be formed as particles, which can have a spherical or near-spherical shape. Such particles may have an average size between about 10 nm and a few millimeters, or between about 10 nm and 1,000 μm, preferably between about 10 nm and 500 μm, more preferably between about 10 nm and 50 μm, or even more preferably between about 10 nm and 6 μm.

Such thermoset particles may be used, for example, as supports for catalysts, and they may be metallized using catalytically active metals such as silver, gold, etc. Alternatively, they may be impregnated or coated with catalytically active compounds and used in heterogenous catalysis processes.

Thermoset particles may also be used as molecular sieves, and the pore sizes in such particles may be adjusted, e.g., by selecting particular prepolymerization conditions, fillers, reaction times in the emulsion, dispersion or suspension, polymerization processes, amounts and types of cross-linkers used, amount of surfactant in the emulsion, dispersion or suspension reaction, etc. Fillers which may be washed out from such particles, or which can be decomposed chemically or thermally or in combinations thereof, can be used to provide or adjust porosity in the thermoset particles.

Thermoset particles may also be used as supports or carriers in biotechnology applications, for example, as supports for cell cultures, enzymes, micro-organisms in bioreactor systems, etc. Such particles may also be used in pharmacy and medicine applications as carriers or supports for therapeutically and/or diagnostically active agents, e.g., as drug delivery devices or implants.

Carbonization

Thermoset particles or fibers produced using methods in accordance with exemplary embodiments of the present invention can be subjected to a carbonization and/or pyrolysis treatment. Spherical carbon-based particles may be produced by exposing thermoset particles to elevated temperatures, e.g., in a range between about 100° C. and 3500° C. Such exposure can be performed under an oxidizing or inert gas atmosphere. Such carbon-based particles can be used, e.g., for biological and/or pharmacological applications. Carbonization and/or pyrolysis conditions can be selected to produce glassy amorphous carbon-based material, e.g., “glassy polymeric carbon,” which may be non-crystalline and non-electrically conductive, and can be reddish or brownish in color. Spherical carbons-based particles can also be produced which may include graphitic carbon, where the particles may be electrically conductive, by appropriate selection of pyrolysis and/or carbonization conditions.

The temperatures used in a carbonization procedure can be, e.g., between about 20° C. and 3500° C., or between about 50° C. and 2500° C., or preferably between about 100° C. and 1500° C., or more preferably between about 200° C. and 1000° C., or even more preferably between about 250° C. and 800° C.

In certain exemplary embodiments of the present invention, a thermal treatment can be performed using a laser, e.g. by selective laser sintering (SLS).

The carbonization procedure can be performed in different atmospheres such as an inert atmosphere, e.g., nitrogen, SF₆, or noble gases such as argon, or mixtures thereof. Carbonization may also be performed in an oxidizing atmosphere such as oxygen, carbon monoxide, carbon dioxide or nitrogen oxide. Alternative, carbonization may be performed in an atmosphere that can include a mixture of inert gases and reactive gases such as, e.g., hydrogen, ammonia, C₁-C₆ saturated aliphatic hydrocarbons such as methane, ethane, propane and butene, or mixtures of these or other oxidizing gases. In certain exemplary embodiments of the present invention, the atmosphere provided during a carbonization procedure may be substantially free of oxygen, e.g., the oxygen content may be below about 10 ppm, or preferably below about 1 ppm.

Particles which may be processed using a carbonization procedure as described herein can be further treated with oxidizing and/or reducing agents. For example, such particles can be exposed to elevated temperatures in oxidizing atmospheres such as, e.g., oxygen, carbon monoxide, carbon dioxide, nitrogen oxide or similar oxidizing agents. Such oxidizing agents can also be mixed with inert gases such as noble gases. Partial oxidation of such particles can be achieved, for example, at elevated temperatures between about 50° C. and 800° C. Liquid oxidizing agents can also be used such as, for example, concentrated nitric acid. Particles may be partially or more completely oxidized, e.g., by contacting them with concentrated nitric acid at temperatures above room temperature. Spherical or near-spherical carbonized particles produced using the exemplary methods described herein can have sizes ranging from nanometers up to millimeters.

In certain exemplary embodiments of the present invention, hollow spherical particles may also be produced by using a polar suspension medium such as water, where a hydrophobic co-solvent, e.g., xylene, can be introduced into the reaction mixture either with the thermosetting resin or with crosslinkers. Such a procedure can produce spherical particles which include a core of the hydrophobic solvent surrounded by thermoset material. The solvent may then be evaporated or pyrolyzed using a carbonization procedure to produce substantially hollow particles.

Use of Carbonized Particles

Thermoset particles produced using exemplary methods described herein, including carbonized glassy polymeric carbon particles, may be used as carriers, for example, in oncologic applications. In such applications, spherical particles may be stable in a gastrointestinal region, and they can be impregnated with therapeutically and/or diagnostically active agents. Such particles may also be enterically coated to provide a release of such active agents at a defined location in a patient's body. Thermoset particles may also be used, e.g., in local radiation therapy applications by introducing radioactively radiating materials into the particles.

Thermoset particles may also be used in bioprocessing applications, for example, as cell culture supports, where the particles may be functionalized using, e.g., calcium, sulfur, magnesium, or cobalt ions, etc. For example, salts having buffering properties may be incorporated into the spherical particles, which can prevent or delay over-acidification of a cell culture medium by excreted metabolism products. Such particles may also include magnetic functional additives or fillers, which can facilitate separation of the magnetic cell culture support particles from the culture medium by exposing the culture to a magnet or electromagnet.

Thermoset particles produced in accordance with exemplary embodiments of the present invention can be contacted, incubated, impregnated, coated or infiltrated with one or more agents which can include, e.g., therapeutically active agents, biologically active agents, diagnostic agents, enzymes, living organisms such as cells or microorganisms, or combinations thereof. Such particles can be used, for example, as a support for culturing of cells and/or biological tissue in vivo or in vitro, or as a scaffold for tissue engineering, for example, in a living organism or in a bioreactor. Thermoset particles treated with such agents can be used, e.g., to produce a direct or indirect therapeutic effect, or for direct or indirect diagnostic purposes, or combinations thereof.

### EXAMPLE 1

A liquid suspension medium was prepared by combining 500 g of deionized water, 25 g of a 5 wt % aqueous polyvinyl alcohol solution and 12.5 g of a 2.5 wt % aqueous methylcellulose solution in a 2000 ml beaker. The suspension was warmed to 35° C. and stirred continuously at 600 rpm. 150 g of a commercially available Epoxy-Novolac (DEN 438, Dow Chemical) was melted at about 80° C. and stirred until homogenous. The melt was then slowly added to the suspension medium while stirring continuously to form a reaction mixture.

After the addition of the Epoxy-Novolac was completed, the temperature of the reaction mixture was raised to about 80° C., and 7.5 g of a cross-linker solution comprising 20 wt % phenylendiamine and 20 wt % ethylendiamine in 50 wt % diethylamine and 10 wt % xylol was subsequently added. After about 1 hour of stirring at constant temperature, yellowish polymer droplets were observed in the stirred suspension. After 15 hours of stirring, the resulting polymerized material was filtered, washed with water, filtered again and dried. The polymerized material had a form of yellowish polymerized spherical particles. Then particles were classified using screening techniques and the following distribution of the particle sizes was observed: Total weight of particle having a size >2000 μm: 7.61 g; particle sizes >1120 μm: 9.3 g; particle sizes >850 μm: 13.49 g; particle sizes >425 μm: 13.7 g; particle sizes >300 μm: 8.2 g; particle sizes >212 μm: 6.4 g; particle sizes >100 μm: 1.7 g. The overall yield of polymerized material based on the amount of Epoxy-Novolac used was about 35 wt %.

This exemplary procedure was repeated 10 times, yielding average values for particle size fractions shown in Table 1. The particles were heated in a conventional convection oven to a temperature of about 300° C. The spherical particles retained their form and no sintering was observed, which may indicate that cross-linking and/or curing of the thermosetting resin was complete.

TABLE 1

| Screening | Average weight | Standard |
|---|---|---|
| fraction | [g] | deviation |
| >2000μ | 3.51 | 3.57 |
| >1120μ | 7.81 | 5.42 |
| >850μ | 16.39 | 2.96 |
| >425μ | 29.76 | 13.93 |
| >300μ | 10.43 | 3.87 |
| >212μ | 3.56 | 2.84 |
| >100μ | 0.87 | 0.72 |
| Total | 69.43 | 15.44 |
| Yield | 46.28% | 10.29% |

### EXAMPLE 2

Thermoset particles were prepared in accordance with the procedure described in Example 1, using 15 g of the cross-linker solution. Table 2 shows the average particles size distribution obtained from 10 batches of particles.

The spherical particles were dimensionally stable when heated to a temperature of about 300° C. and no sintering was observed, which may indicate that the cross-linking/curing of the thermosetting resin was completed.

TABLE 2

| Screening | average weight | Standard |
|---|---|---|
| fraction | [g] | deviation |
| >2000μ | 1.60 | 0.40 |
| >1120μ | 5.54 | 0.97 |
| >850μ | 9.39 | 6.02 |
| >425μ | 65.19 | 23.00 |
| >300μ | 18.58 | 9.05 |
| >212μ | 3.83 | 0.78 |
| >100μ | 0.80 | 0.31 |
| Total | 104.03 | 31.94% |
| Yield | 69.35% | 21.29 |

### EXAMPLE 3

A liquid suspension medium was prepared in accordance with the technique described in Examples 1 and 2.150 g of a commercially available Epoxy-Novolac (DEN 438, Dow Chemical) was melted at a temperature of about 80° C. and stirred until the liquid was homogenous. 7.5 g of the cross-linker solution described in Example 1 was added to the melted thermosetting resin and stirred for about 10 minutes at constant temperature. The melt/crosslinker mixture was then added to the suspension medium under continuous stirring and the temperature was raised to about 80° C.

After about 35 minutes, yellowish polymer droplets were observed in the stirred suspension. The reaction was stopped after 15 hours and the resulting polymerized material was filtrated, washed with water, filtrated again and dried. Orange-colored polymer spheres were observed, and these particles were classified using screening techniques. This procedure was performed 8 times, and the observed particle size distribution is shown in Table 3. The polymers spheres were dimensionally stable and no sintering was observed when they were heated to about 300° C.

TABLE 3

| Screening | average weight | Standard |
|---|---|---|
| fraction | [g] | deviation |
| >2000μ | 45.34 | 12.59 |
| >1120μ | 40.66 | 12.23 |
| >850μ | 8.77 | 0.59 |
| >425μ | 8.42 | 0.96 |
| >300μ | 0.62 | 0.19 |
| >212μ | 0.00 | 0.00 |
| >100μ | 0.00 | 0.00 |
| Total | 110.5 | 17.45 |
| Yield | 73.67% | 11.64% |

### EXAMPLE 4

The procedure described in Example 3 was repeated using 10 g of the cross-linker solution. Table 4 below shows the average particle size distribution observed from the 8 batches thus produced.

### EXAMPLE 5

130 g of a commercially available Epoxy-Novolac (DEN 438, Dow Chemical) was melted at a temperature of about 80° C. and stirred until the liquid was homogenous. 20 g of kaolin (Amber Kaolinwerke Eduard Kick GmbH & co. KG) was added to the melt and stirred for 1 hour. The kaolin-containing melt was then added to the liquid suspension medium described in Example 1 while being stirred. The reaction mixture was heated to a temperature of about 80° C., and 7.5 g of the cross-linker solution described in Example 1 was added. After about 1 hour, slightly yellow polymer droplets were observed. The reaction was terminated after 15 hours of stirring and the polymerized material was filtrated, washed with water, filtrated again and dried.

TABLE 4

| Screening | Average weight | Standard |
|---|---|---|
| fraction | [g] | deviation |
| >2000μ | 48.37 | 1.78 |
| >1120μ | 45.33 | 2.06 |
| >850μ | 10.00 | 2.93 |
| >425μ | 16.40 | 7.98 |
| >300μ | 3.73 | 2.27 |
| >212μ | 1.20 | 0.46 |
| >100μ | 0.67 | 0.60 |
| Total | 118.55 | 12.09 |
| Yield | 79.03% | 8.06% |

The resulting product had a form of slightly yellow polymeric spheres. 10 g of the product were then carbonized in a conventional tube furnace in a nitrogen atmosphere using a heating ramp rate of 5 K/min. up to a temperature of 400° C. followed by a holding time of 30 minutes. The surface of a polymer sphere was then analyzed using energy dispersive X-ray analysis (EDX). The composition observed using this technique is shown in Table 5.

### EXAMPLE 6

To increase the mineral proportion of carbonized polymer particles produced in accordance with an exemplary embodiment of the present invention, the procedure described in Example 5 was repeated, adding 7.5 g of the cross-linker solution directly to the Epoxy-Novolac/kaolin melt mixture and stirring for 10 minutes before adding this mixture of polymer, kaolin and cross-linker to the liquid suspension medium. After about 40 minutes, slightly yellow polymer droplets were observed. The reaction was terminated after 15 hours and the polymerized product was filtrated, washed in water, filtrated again and dried. The thermosetting particles thus obtained had a form of slightly yellow polymerized spherical particles.

TABLE 5

| Element | Wt % | Atom % |
|---|---|---|
| CK | 9.37 | 20.57 |
| OK | 32.98 | 54.37 |
| MgK | 0.54 | 0.58 |
| AlK | 1.24 | 1.22 |
| SiK | 0.67 | 0.63 |
| SK | 5.98 | 4.92 |
| CaK | 1.51 | 0.99 |
| BaL | 18.80 | 3.61 |
| TiK | 9.76 | 5.38 |
| ZnK | 19.14 | 7.72 |

10 g of the particles were carbonized in a tube furnace under a nitrogen atmosphere using a heating ramp rate of 5 K/min. up to a maximum temperature of 400° C., followed by a holding time of 30 minutes at that temperature. The composition of the particles was characterized using EDX techniques. The observed composition of the particles is shown in Table 6.

### EXAMPLE 7

To produce hollow particles in accordance with an exemplary embodiment of the present invention, 128.55 g of a commercially available Epoxy-Nonolac (DEN 438, Dow Chemical) was melted at 80° C. and stirred until the liquid was homogenous. 21.45 g of kaolin (Amberger Kaolinwerke Eduard Kick GmbH & Co. KG) was added to the melt and stirred for 1 additional hour. The kaolin-containing melt was subsequently combined under stirring with 6.43 g of the cross-linker solution described in Example 1. After about 10 minutes of stirring, this mixture was added to the suspension medium described in Example 1 to form a reaction mixture. The temperature of the reaction mixture was raised to about 80° C., and pinkish polymer droplets were observed after 1 hour in the stirred suspension. The reaction was terminated after 15 hours and the product obtained was filtrated, washed with water, filtrated again and dried.

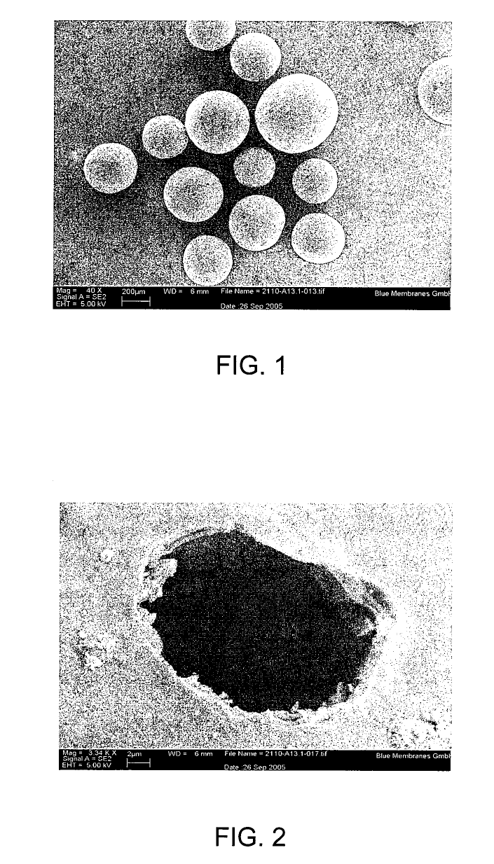

The resulting polymerized particles were pyrolyzed in a commercial chamber furnace under a nitrogen atmosphere. An exemplary scanning electron microscopy (SEM) image of a portion of the 425 to 800 μm sieved fraction of particles is shown in FIG. 1. FIG. 2 is an exemplary magnified SEM image of one such spherical particle having an artificially produced wall defect which shows the hollow form of the particle.

### EXAMPLE 8

To produce porous carbon-based particles in accordance with a further exemplary embodiment of the present invention, 140 g of Epoxy-Novolac was melted at a temperature of about 80° C. and stirred until the liquid was homogenous. 10 g of kaolin, 10 g of polyethylenoxide (MW 100000, Sigma-Aldrich) and 10 g of paraffin (melting point 55-65° C., Sigma-Aldrich) were added to the melt and stirred for 1 hour. Subsequently, 10 g of the cross-linker solution described in Example 1 was added and the resulting melt mixture was stirred for 10 minutes. The melt mixture was then added to the suspension medium described in Example 1. The temperature of the reaction mixture was raised to about 80° C., and dark brown colored polymer droplets were observed in the stirred suspension after abut 1 hour. The reaction was terminated after about 15 hours and the polymerized product was filtrated, washed with water, filtrated again and dried.

TABLE 6

| Element | Wt % | Atom % |
|---|---|---|
| CK | 10.41 | 17.92 |
| OK | 44.00 | 56.84 |
| MgK | 1.06 | 0.90 |
| AlK | 0.41 | 0.31 |
| SiK | 0.87 | 0.64 |
| SK | 10.86 | 7.00 |
| CaK | 30.20 | 15.57 |
| BaL | 0.00 | 0.00 |
| TiK | 1.08 | 0.46 |
| ZnK | 1.11 | 0.35 |

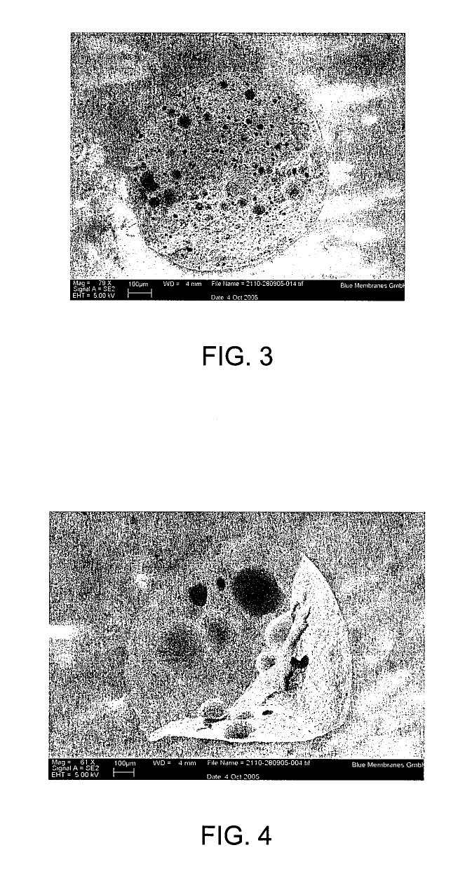

The resulting spherical particles were carbonized at a temperature of about 600° C. in a conventional chamber furnace under a nitrogen atmosphere. FIG. 3 shows an exemplary SEM image of a cross-sectional surface of a particle exhibiting a porous structure, with an average porous size of about 5 to 10 μm.

### EXAMPLE 9

To produce porous carbon-based particles impregnated with titanium oxide in accordance with a still further exemplary embodiment of the present invention, 140 g of a commercially available Epoxy-Novolac (DEN 438, Dow Chemicals) were melted at a temperature of about 80° C. and stirred until the melt was homogenous. 10 g of titanium dioxide (Aeroxide P25, Degussa AG), 10 g polyethylenoxide (MW 100000 Sigma-Aldrich) and 10 g of paraffin (melting point 55-65° C., Sigma-Aldrich) were added to this melt, and the resulting melt mixture was stirred for an additional hour. 10 g of the cross-linker solution described in Example 1 was then added to the melt mixture, which was stirred for an additional 10 minutes. The melt mixture was then added to the suspension medium described in Example 1. The temperature was raised to about 80° C. and after about 1 hour yellowish polymer droplets were observed. The reaction was terminated after 15 hours and the resulting polymerized product was filtrated, washed with water, filtrated again and dried.

The resulting product, having a form of thermoset spheres, was pyrolyzed at a temperature of about 600° C. in a nitrogen atmosphere in a conventional chamber furnace. FIG. 4 shows an exemplary SEM image of a cut spherical particle produced using the procedure described in the present example. The spherical particle has a porous structure that includes visible macro pores of about 100 μm size and small micropores.

### EXAMPLE 10

The particles produced in accordance with the exemplary procedure described in Example 9, taken from a screening fraction below <425 μm, were treated at 400° C. in a carbon dioxide atmosphere for 30 minutes. The pore volume of the particles was determined using sorption techniques. The sample particles were prepared for 4 hours at 250° C. under vacuum and then the sorption measurement was performed using carbon dioxide at a temperature of 273 Kelvin on a Quantachrome Nova instrument. A 65-point-isotherm curve was recorded for each sample analyzed, and micropores could be detected in each sample. Analysis of the measurement data was performed using a GCMC (Grand Canonical Monte Carlo) simulation. This sorption technique may be used with pore diameters between about 0.35 and 1.5 nm.

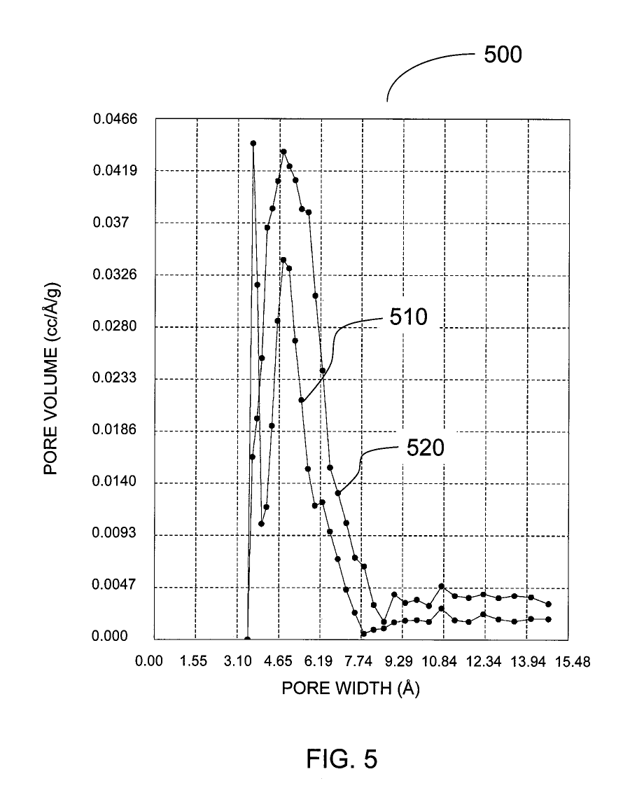

FIG. 5 shows an exemplary graph 500 of a pore volume distribution obtained using the sorption technique described herein. Measurements shown in FIG. 5 include data for two samples, D5-3 510 and D11-5 520. The analyzed samples exhibited characteristics typical of a molecular sieve material.

### EXAMPLE 11

Porous carbon-based spherical particles obtained using the techniques described in Example 8 were thoroughly flashed with an ethanol-water mixture (v/v 50%/50%) and then autoclaved. Triple batches, each containing 2 ml of particles and 3 ml of culturing medium, were provided in commercial 6-well plates. A COS-7 (Cambrex) cell line was used with a culturing medium of commercially available DMEM with 10% FCS and 1% P/S (Cambrex), and a CHO-K1 (Cambrex) cell line was used with a culturing medium containing Ham's F12 with 10FCS and 1% P/S (Cambrex). Control triples were also cultivated in 6-well plates (each having 2 ml micro carrier volume and 3 ml culturing volume) with commercial micro carriers cytopore, cytodex 1 and cytodex 2 (Amersham), biosilon (Nunc) and cultisphere (Percell Biolytica).

The batches were seeded with 1×10⁵ cells (absolute) in each well and incubated for 30 minutes at 37.5° C. in an incubator under 5% CO₂. After 30 minutes the supernatant was removed from the wells and the particle or carriers, respectively, were carefully transferred into new 6-well plates. The cells were then removed from the carriers using 1 ml of trypsin-EDTA. After 2 minutes, removal of the cells was terminated with 1 ml of medium each. Cells were thoroughly re-suspended with a pipette and a 200 μl aliquot was taken from each sample. The aliquot was transferred into a 10 ml CasyTon and the cell number was determined using a CASY cell counter (Schärfe Systems). Cultures grown with the carbon-based thermoset particles having a mineral proportion exhibited the highest cell number. The experiment was repeated three times. Table 7 shows the cell numbers observed for each particle or micro carrier volume.

TABLE 7

| | cells/[ml | |
|---|---|---|
| PE 30 min | carrier] | SD |
| | COS-7 | |
| Cultisphere | 45453 | 5.62% |
| Cytodex 1 | 42873 | 2.04% |
| Cytodex 3 | 46223 | 5.66% |
| Cytopore | 25613 | 8.98% |
| Biosilon | 20110 | 2.04% |
| Carbon-particles | 67610 | 0.66% |
| | CHO-K1 | |
| Cultisphere | 13677 | 0.73% |
| Cytodex 1 | 23163 | 10.70% |
| Cytodex 3 | 21833 | 7.58% |
| Cytopore | 30360 | 4.10% |
| Biosilon | 14873 | 4.21% |
| Carbon-particles | 58130 | 2.78% |

### EXAMPLE 12

2 mg of porous particles produced in accordance with the exemplary technique described in Example 8, taken from the sieve fraction between 45 μm and 125 μm, were impregnated with an ethanolic Paclitaxel (Ptx) solution. Initially, radioactively labelled Paclitaxel (14C-Ptc) (Paclitaxel-[2-benzoyl ring-UL-14C]; Lot 043K9418/19; Sigma Chemicals, Germany) was blended with non-labeled Paclitaxel (Ptx) (Paclitaxel semisynthetic; Lot 062K1767 Sigma Chemicals, Germany) at a ratio of 1:150 in a solution containing 96% ethanol by volume (Riedel-de-Haen, Germany) to form a drug solution. 50 μl of this solution was added to the particles, so that the total particle surface was wetted with drug solution.

After the particles were dried for 3 days, they were over-layered in glass vessels with 2 ml or 5 ml of an isotonic phosphate buffer (0.05M PBS, pH 7.4 adjusted with 2M-HCl; 2.092 g Na2HPO4.2H2O; 0.6555 g NaH2PO4.H2O; NaCl 8.5 g and 1000 ml in distilled water; Fluka, Germany). The impregnated particles were stored in a incubator at 37° C. At regular time intervals, the buffer was removed and 1 ml of the supernatant was mixed with 5 ml of a scintillation cocktail (Ultima GoldO LS Cocktail, Packard BioScience, Netherlands), and the residual medium was discarded. The amount of 14C-Ptx released was determined using a liquid scintillation counting technique (LSC) (Tri-Carb 2100TR, Packard BioScience, Germany), and extrapolated to the total amount of Ptx used. The samples were measured for a measurement period of 20 minutes.

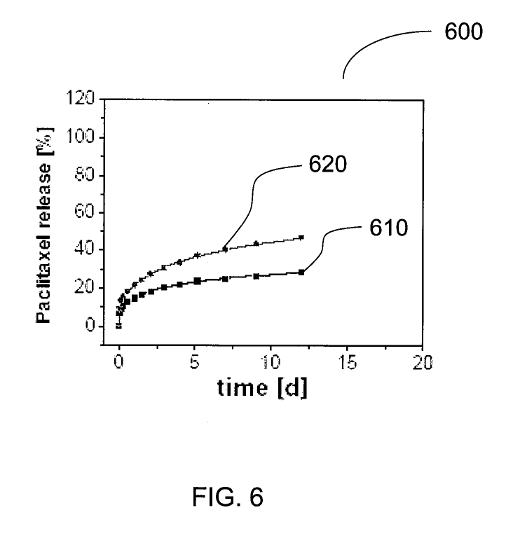

FIG. 6 shows an exemplary graph 600 of the release rate of Paclitaxel observed using the technique described herein for samples using 2 ml of buffer 610 and 5 ml of buffer 620. The data shown in FIG. 6 indicate that the Paclitaxel is released continuously and slowly from the carrier particles.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, all publications, patents and patent applications referenced herein, to the extent applicable, are incorporated herein by reference in their entireties.

What is claimed is:

1. A method for manufacturing a thermoset material, comprising:
providing a reaction mixture comprising at least one thermosetting resin, at least one crosslinker, at least one surface active agent, and at least one solvent; and
at least partially crosslinking the at least one thermosetting resin to obtain a thermoset material.

2. The method of claim 1, further comprising, after at least partially crosslinking the at least one thermosetting resin, at least partially removing the solvent from the reaction mixture.

3. The method of claim 1, further comprising at least one of spraying or electro-spinning the reaction mixture, wherein the thermoset material has a form of a fiber.

4. The method of claim 1, wherein the reaction mixture is provided by:
mixing the at least one crosslinker with the at least one thermosetting resin to form a resin mixture; and
adding the resin mixture to a solvent mixture comprising the at least one solvent and the at least one surface active agent.

5. The method of claim 1, wherein the reaction mixture is provided by adding the at least one crosslinker to a particular mixture comprising the at least one thermosetting resin.

6. The method of claim 1, wherein the reaction mixture is provided by adding the at least one thermosetting resin to a particular mixture comprising the at least one solvent and the at least one surface active agent, wherein the resin has a form of a liquid.

7. The method of claim 1, wherein the reaction mixture is provided by at least one of pouring, spraying or electro-spinning the at least one thermosetting resin into a particular mixture comprising the at least one solvent and the at least one surface active agent.

8. The method of claim 1, wherein the reaction mixture is provided by:
melting the at least one thermosetting resin;
adding the at least one crosslinker to the at least one thermosetting resin to provide a partially crosslinked resin mixture; and
adding the partially crosslinked resin mixture to the at least one solvent and the at least one surface active agent.

9. The method of claim 1, wherein providing the reaction mixture comprises:
melting at least one thermosetting resin;
adding the at least one thermosetting resin to a solvent mixture comprising the at least one solvent and the at least one surface active agent to provide a particular mixture; and
adding the at least one crosslinker to the particular mixture.

10. The method of claim 1, wherein the reaction mixture comprises at least one of a dispersion, a suspension or an emulsion.

11. The method of claim 1, wherein the at least one thermosetting resin is crosslinked using at least one of a polycondensation reaction or a polyaddition reaction.

12. The method of claim 1, wherein the at least one surface active agent comprises at least one of a surfactant, an emulsifier, or a dispersant.

13. The method of claim 1, wherein the reaction mixture further comprises at least one rheology modifier.

14. The method of claim 1, further comprising adding a functional additive to the at least one thermosetting resin.

15. The method of claim 14, wherein the functional additive comprises at least one of a catalyst, a plasticizer, a lubricant, a flame resistant, a glass, a glass fiber, a carbon fiber, cotton, a fabric, a metal powder, a metal compounds, silicon, silicon oxide, a zeolite, titanium oxide, zirconium oxide, aluminium oxide, aluminium silicate, talcum, graphite, soot, a phyllosilicate, clay, a mineral, a salt, a polymer or a solvent.

16. The method of claim 1, wherein the crosslinking step comprises adding an initiator to the reaction mixture.

17. The method of claim 1, wherein the crosslinking step comprises exposing the reaction mixture to at least one of a heat or a radiation.

18. The method of claim 17, wherein the radiation is at least one of an ultraviolet radiation, an infrared radiation, a visible light or a gamma radiation.

19. The method of claim 16, further comprising heating the reaction mixture to a temperature between about 20° C. and about 200° C.

20. The method of claim 16, further comprising heating the reaction mixture to a temperature between about 80° C. to about 150° C.

21. The method of claim 1, wherein the thermoset material has a form of an approximately spherical particle.

22. The method of claim 21, wherein the approximately spherical particle is at least one of porous or substantially hollow.

23. The method claim 21, wherein the approximately spherical particle is at least one of contacted, incubated, impregnated, coated or infiltrated with at least one of a therapeutically active agent, a biologically active agent, a diagnostic agent, an enzyme or a living organism.

24. The method of claim 2, wherein the removing the solvent comprises at least one of filtering, decanting or evaporating the reaction mixture.

25. The method of claim 1, further comprising drying the thermoset material.

26. The method of claim 25, wherein the thermoset material is dried under at least one of a reduced pressure or a vacuum.

27. The method of claim 1, further comprising at least one of carbonizing or sintering the thermoset material.

28. A thermoset material produced by procedures comprising:
providing a reaction mixture comprising at least one thermosetting resin, at least one crosslinker, at least one surface active agent, and at least one solvent; and
crosslinking the at least one thermosetting resin to obtain a thermoset material,
wherein the thermoset material has a form of at least one of an approximately spherical particle or a fiber.
